(19) United States
(12) Patent Application Publication
(10) Pub. No.: US 2020/0039074 A1
(43) Pub. Date: Feb. 6, 2020

(54) INTERACTION BETWEEN MOBILE ROBOT AND METHOD

(71) Applicant: LG ELECTRONICS INC., Seoul (KR)

(72) Inventor: Jae Yoon JEONG, Seoul (KR)

(73) Assignee: LG ELECTRONICS INC., Seoul (KR)

(21) Appl. No.: 16/598,885

(22) Filed: Oct. 10, 2019

(30) Foreign Application Priority Data
May 8, 2019 (KR) PCT/KR2019/005474

(51) Int. Cl. B25J 9/16; B25J 11/00

(52) U.S. Cl. CPC B25J 9/1666; B25J 11/0085; B25J 9/1697

(57) ABSTRACT

A mobile robot capable of interacting with at least one target object to be sensed and a method for enabling interaction between the mobile robot and the at least one target object are disclosed. During traveling, the mobile robot may collect information about a change in movement or sound of the target object, which is a moving object capable of emotionally reacting to the mobile robot, and the mobile robot may learn the collected information.

### CROSS-REFERENCE TO RELATED APPLICATION

This present application claims benefit of priority to International Patent Application No. PCT/KR2019/005474, entitled “Interaction between mobile robot and method,” filed on May 8, 2019, in the Korean Intellectual Property Office, the entire disclosure of which is incorporated herein by reference.

### TECHNICAL FIELD

The present disclosure relates to a mobile robot and a method for enabling interaction between the mobile robot and at least one target object to be sensed. More specifically, the present disclosure relates to technology for enabling a mobile robot designed to rotate and travel to automatically recognize at least one target object to be sensed (hereinafter referred to as a target object), reducing movement of the mobile robot according to sound and movement of the at least one target object, and preventing the mobile robot from approaching a target object that expresses a negative reaction toward the mobile robot.

### BACKGROUND ART

The following contents described below are merely disclosed for the purpose of providing background information related to embodiments of the present disclosure, and the described contents are not always to be construed as a matter of the prior art.

Robots have been developed for industrial use, and have become responsible for parts of factory automation. Recently, the number fields in which robots are being applied is rapidly increasing, with medical robots and aerospace robots now being used, for example. In addition, robots for use in ordinary households are also being developed. Among the above-mentioned robots, a robot that is capable of autonomous traveling is referred to as a mobile robot.

In particular, a representative example of a robot used at home is a robot vacuum cleaner. A cleaning robot is a device that suctions dust or foreign materials from a target region to be cleaned while autonomously traveling around the target region, thereby cleaning the target region.

In more detail, the mobile robot is capable of autonomously moving from one place to another, and includes a plurality of sensors that allow the mobile robot to avoid collision with obstacles while in motion.

To this end, the mobile robot may include an infrared (IR) sensor, an ultrasonic sensor, and the like. The infrared sensor may determine the distance between an obstacle and the mobile robot based on the amount of light reflected from the obstacle or based on the time when the reflected light is received. In contrast, the ultrasonic sensor may emit ultrasonic waves having a predetermined period. If ultrasonic waves reflected from the obstacle are detected, the ultrasonic sensor may determine the distance to the obstacle based on a time difference between the ultrasonic wave emission time and a specific moment at which ultrasonic waves reflected from the obstacle are received.

Such a mobile robot may determine the distance to an obstacle, and avoid collision with the obstacle. For example, Korean Patent Registration No. 10-0669892 discloses a mobile robot having an obstacle avoidance function and a method therefor, in which different sensors having different sensing areas are provided so as to increase the reliability of data acquired by sensing an obstacle, so that the mobile robot can avoid collision with the obstacle with higher reliability.

However, the mobile robot having an obstacle avoidance function and the method therefor disclosed in Korean Patent Registration No. 10-0669892 relates to technology for allowing the mobile robot to avoid collision with a static obstacle, and Korean Patent Registration No. 10-0669892 has no specific disclosure regarding a method for a mobile robot to avoid an obstacle when the obstacle is a moving object.

Since the mobile robot disclosed in Korean Patent Registration No. 10-0669892 has been designed to consider only situations in which the mobile robot moves to avoid collision with a static obstacle, the mobile robot is unable to reliably avoid collision with a target object that moves around in a home.

In another example, Korean Patent Registration No. 10-1878827 discloses an apparatus and method for allowing a mobile robot to detect an obstacle based on a multi-channel LiDAR (Light Detection and Ranging) sensor, and a mobile robot including the same, in which the mobile robot can detect an obstacle using the multi-channel LiDAR scheme. Said disclosure relates to technology for allowing the mobile robot to measure a distance between the obstacle and the mobile robot by acquiring peripheral environmental information as three-dimensional (3D) spatial information, and to avoid collision with the obstacle based on the measured distance.

The apparatus and method for allowing a mobile robot to detect an obstacle based on a multi-channel LiDAR sensor disclosed in Korean Patent Registration No. 10-1878827 may extract information of a vertical environment such as a wall and information of an obstacle based on 3D spatial information, and may plan a traveling route of the mobile robot based on the extracted vertical environmental information and the distance to the obstacle.

Accordingly, the apparatus and method for allowing a mobile robot to detect an obstacle based on a multi-channel LiDAR sensor disclosed in Korean Patent Registration No. 10-1878827 have disadvantages in that it is difficult to calculate the distance between a moving obstacle and the mobile robot, and to recognize a change in movement of the mobile robot when the mobile robot and the obstacle move into close proximity to each other.

There is thus a need for a method capable of measuring the distance between a moving obstacle and a mobile robot, changing a traveling route of the mobile robot due to the presence of the moving obstacle, and avoiding collision between the mobile robot and the moving obstacle.

### CITED REFERENCES

### Patent Documents

Korean Patent Registration No. 10-0669892 (2007.01.10)

Korean Patent Registration No. 10-1878827 (2018.07.10)

### DISCLOSURE OF INVENTION

### Technical Problem

The present disclosure is directed to providing technology for enabling a mobile robot to avoid collision with at least one target object to be sensed (hereinafter referred to as a target object) according to a change in movement or sound of the target object when the mobile robot and the target object are in close proximity to each other.

The present disclosure is further directed to providing technology for enabling a mobile robot to learn a change in movement or sound of at least one target object when the mobile robot and the at least one target object are in close proximity to each other, and when the mobile robot subsequently moves into close proximity with the target object again, adjusting operation of the mobile robot such that the amount of change in movement or sound of the target object decreases, by referring to the learned data.

The present disclosure is further directed to providing technology for controlling driving of a mobile robot such that, when the mobile robot and at least one target object are in close proximity to each other, the change in movement or sound of the target object decreases, so as to reduce psychological discomfort or inconvenience of the target object.

### Solution to Problem

A mobile robot capable of interacting with at least one target object to be sensed according to an embodiment of the present disclosure may include a main body forming an exterior of the mobile robot, a traveling unit configured to move and rotate the main body, a sensor unit including at least one sensor, configured to sense movement or sound of the at least one target object located within a predetermined distance from the main body, and a control unit configured to control movement of the main body while communicating with the traveling unit and the sensor unit.

Specifically, the control unit may determine whether a distance between the main body and the at least one target object is shorter than the predetermined distance, ascertain an identity of the target object when the distance between the main body and the target object is shorter than the predetermined distance, record an execution operation executed by the mobile robot in an area in which the main body is located within the predetermined distance from the target object and sense a change in movement or sound of the target object of which the identity has been ascertained, and adjust operation of the mobile robot such that the amount of change in movement or sound of the target object of which the identity has been ascertained decreases.

That is, when the mobile robot is in close proximity to target object of which the identity has been ascertained, a change in movement or sound of target object may occur. Movement of the mobile robot may be adjusted such that the amount of change in movement or sound of the target object of which the identity has been ascertained decreases, thereby enabling driving of the mobile robot to be controlled through interaction between the mobile robot and the target object of which the identity has been ascertained.

The control unit of the mobile robot according to an embodiment of the present disclosure may record an execution operation executed by the mobile robot in an area in which the main body of the mobile robot is located within the predetermined distance from the target object, and sense a change in movement or sound of the target object of which the identity has been ascertained. When a change in movement or sound of the target object of which the identity has been ascertained is sensed, the control unit may learn, in association with the identity of the target object, the execution operation of the mobile robot and the change in movement or sound of the target object.

In other words, there may be a plurality of target objects to be sensed, each having unique information. In this case, when the distance between the mobile robot and the target objects to be sensed is shorter than a predetermined distance and the mobile robot ascertains an identity of each target object, different amounts of change in movement or sound may be stored for each target object. As a result, movement of the mobile robot may be controlled according to the amount of change in movement or sound of each target object of which the identity has been ascertained.

When the control unit of the mobile robot according to this embodiment of the present disclosure has completed the learning of the execution operation of the mobile robot and the change in movement or sound of the at least one target object in association with the identity of the target object, the control unit may determine whether to adjust the operation of the mobile robot by referring to a correlation between the execution operation of the mobile robot and the change in movement or sound of the target object. That is, when the target object of which the identity has been ascertained and the mobile robot are in close proximity to each other, the control unit may analyze the change in movement or sound of the target object of which the identity has been ascertained, and control movement of the mobile robot on the basis of the analysis.

In more detail, when the main body is located within a predetermined distance from the at least one target object of which the identity has been ascertained and there is a change in movement or sound of the target object, the mobile robot according to this embodiment of the present disclosure may cause the amount of change in movement or sound of the target object of which the identity has been ascertained to decrease, resulting in inconvenience or discomfort of the target object, caused by the mobile robot, being reduced.

When the control unit of the mobile robot according to this embodiment of the present disclosure has adjusted the operation of the mobile robot such that the change in movement or sound of the target object of which the identity has been ascertained decreases, the control unit may repeatedly perform, at intervals of a predetermined time within a predetermined time range, a process of recording an execution operation executed by the mobile robot in an area in which the main body is located within a predetermined distance from target object, and sensing the change in movement or sound of the target object of which the identity has been ascertained.

Even when the distance between the main body and the target object of which the identity has been ascertained decreases in the above-mentioned recording and sensing process, the amount of change in movement or sound of the target object may remain within a predetermined range, irrespective of the fact that the mobile robot and the target object of which the identity has been ascertained are in close proximity to each other. For example, there may be no change in movement or sound of the target object, irrespective of the fact that the mobile robot and target object of which the identity has been ascertained are in close proximity to each other. In such a case, the control unit may adjust the operation of the mobile robot such that the mobile robot continues to perform an operation that the mobile robot was previously performing.

Accordingly, since the control unit may control driving of the mobile robot while simultaneously learning reactions of the target object toward the mobile robot, inconvenience or discomfort of the target object, caused by the mobile robot, may be prevented, even when the mobile robot is traveling.

Further, the control unit of the mobile robot according to this embodiment of the present disclosure may include a camera for capturing images showing movement of the at least one target object. In this case, the control unit may identify the target object to be sensed based on the captured image of the target object.

A method for enabling interaction between a mobile robot and at least one target object to be sensed according to another embodiment of the present disclosure may include a step of moving and rotating a main body of the mobile robot.

Here, the method may include determining whether the distance between the main body and the at least one target object is shorter than a predetermined distance, ascertaining an identity of the at least one target object when the distance between the main body and the target object is shorter than the predetermined distance, and recording an execution operation executed by the mobile robot in an area in which the main body is located within the predetermined distance from the target object, and sensing a change in movement or sound of the target object of which the identity has been ascertained, and when a change in movement or sound is sensed, adjusting the operation of the mobile robot such that the amount of change in movement or sound of the target object of which the identity has been ascertained decreases. Accordingly inconvenience or discomfort of the target object, caused by the mobile robot, may be prevented, even when the mobile robot is traveling.

In addition, the method according to this embodiment of the present disclosure may include, after sensing the change in movement or sound of the target object of which the identity has been ascertained, learning a correlation between the identity of the target object, the execution operation of the mobile robot, and the change in movement or sound of the target object.

Further, the method according to this embodiment of the present disclosure may further include analyzing the learned correlation between the execution operation of the mobile robot and the change in movement or sound of the object, for each target object identity.

In more detail, a unique identity may be allocated to each target object. When the mobile robot moves to within close proximity of the at least one target object, the identity of the target object of which a change in movement or sound thereof has occurred may be stored based on the allocated identity. Thereafter, when the corresponding target object and the mobile robot subsequently move to within close proximity of each other again, driving of the mobile robot may be controlled, based on the stored identity information, such that the change in movement or sound of the target object decreases.

In addition, the method according to this embodiment of the present disclosure may further include, after adjusting the operation of the mobile robot such that the change in movement or sound of the target object of which the identity has been ascertained decreases, repeatedly recording the execution operation executed by the mobile robot in an area in which the main body is located within a predetermined distance from the target object and sensing a change in movement or sound of the target object of which the identity has been ascertained, at intervals of a predetermined time within a predetermined time range.

In more detail, in the above-mentioned process of repeatedly recording the execution operation executed by the mobile robot in an area in which the main body is located within a predetermined distance from the target object and sensing a change in movement or sound of the target object of which the identity has been ascertained, at intervals of the predetermined time within the predetermined time range, even when the distance between the main body and the target object decreases, the amount of change in movement or sound of the target object may remain within the predetermined range, irrespective of the fact that the mobile robot and the target object are in close proximity to each other For example, there may be no change in movement or sound of the target object of which the identity has been ascertained, irrespective of the fact that the mobile robot and the target object are in close proximity to each other. In this case, the operation of the mobile robot may be adjusted such that the mobile robot continues to perform an operation that the mobile robot was previously performing.

Accordingly, since the control unit may control driving of the mobile robot while simultaneously learning reactions of the at least one target object toward the mobile robot, inconvenience or discomfort of the target object, caused by the mobile robot, may be prevented, even when the mobile robot is traveling.

### Advantageous Effects of Invention

Embodiments of the present disclosure may provide a mobile robot capable of collecting information about a change in movement or sound of at least one moving target object capable of reacting to the mobile robot during traveling of the mobile robot, and learning the collected information. That is, a mobile cleaning robot may be enabled to interact with the at least one moving target object.

In addition, according to the embodiments of the present disclosure, when the distance between a main body of the mobile robot and the at least one target object to be sensed is shorter than a predetermined distance, and the change in movement or sound of the target object indicates a negative reaction toward the mobile robot, the movement of the mobile robot may be controlled such that the negative reaction of the target object toward the mobile robot is reduced.

In addition, after a predetermined time has passed since the movement of the main body of the mobile robot was controlled, when the main body and the target object again move into close proximity to each other, whether or not to control the driving of the main body may be determined based on whether or not there is a change in movement or sound of the target object. In other words, if there is no change in the movement or sound of the target object even though the main body of the mobile robot and the target object have moved into close proximity to each other, the mobile robot may be continuously driven, without any additional movements of the main body being controlled, so that the mobile robot may continue to perform cleaning.

### BRIEF DESCRIPTION OF DRAWINGS

The foregoing and other objects, features, and advantages of the invention, as well as the following detailed description of the embodiments, will be better understood when read in conjunction with the accompanying drawings. For the purpose of illustrating the invention, there is shown in the drawings an exemplary embodiment that is presently preferred, it being understood, however, that the invention is not intended to be limited to the details shown because various modifications and structural changes may be made therein without departing from the spirit of the invention and within the scope and range of equivalents of the claims. The use of the same reference numerals or symbols in different drawings indicates similar or identical items.

FIG. 1 is a perspective view illustrating a mobile robot capable of interacting with at least one target object to be sensed according to an embodiment of the present disclosure.

FIG. 2 is a block diagram illustrating a mobile robot and a target object to be sensed according to an embodiment of the present disclosure.

FIG. 3 is a schematic diagram illustrating a mobile robot and a target object to be sensed according to an embodiment of the present disclosure.

FIG. 4 is a conceptual diagram illustrating a method for enabling interaction between a mobile robot and a target object to be sensed according to an embodiment of the present disclosure.

FIG. 5 is a flowchart illustrating a method for enabling interaction between a mobile robot and at least one target object to be sensed according to an embodiment of the present disclosure.

FIG. 6 is a flowchart illustrating a method for enabling interaction between a mobile robot and at least one target object having a unique identity according to an embodiment of the present disclosure.

FIG. 7 is a flowchart illustrating a method for enabling interaction between at least one target object to be sensed and a mobile robot within a predetermined time range according to an embodiment of the present disclosure.

### BEST MODE FOR CARRYING OUT THE INVENTION

Reference will now be made in detail to the embodiments of the present disclosure, examples of which are illustrated in the accompanying drawings. Wherever possible, the same reference numbers will be used throughout the drawings to refer to the same or like parts. The present disclosure may be implemented in various different forms and is not limited to these embodiments. Although a detailed description of parts unrelated to the description will herein be omitted for clarity of the present disclosure, it should be noted that the omitted parts are not always unnecessary for implementation of devices or systems related to the technical idea of the present disclosure. In the following description, known functions or structures, which may confuse the substance of the present disclosure, are not explained. In addition, the same reference numbers or symbols disclosed in the drawings of the present disclosure may represent parts or components which perform substantially the same function.

Hereinafter, the present disclosure will be described in detail in such a manner that it can be easily implemented by a person having ordinary knowledge in the field to which the present disclosure pertains. However, the present disclosure should not be construed as limited to the embodiments set forth herein. In addition, a detailed description of parts unrelated to the description will be omitted for clarity when the detailed description obscures the subject matter.

In description of the present disclosure, the terms “first” and “second” may be used to describe various components, but the components are not limited by these terms. These terms may be used to distinguish one component from another component. For example, a first component may be called a second component and a second component may be called a first component without departing from the scope of the present disclosure. The term “and/or” may include a combination of a plurality of items or any one of a plurality of items. A singular expression may include a plural expression unless otherwise stated in the context.

In the present application, the terms “including” or “having” are used to indicate that features, numbers, steps, operations, components, parts or combinations thereof described in the present specification are present and presence or addition of one or more other features, numbers, steps, operations, components, parts or combinations is not excluded.

A mobile robot according to the present disclosure will hereinafter be described with reference to the attached drawings.

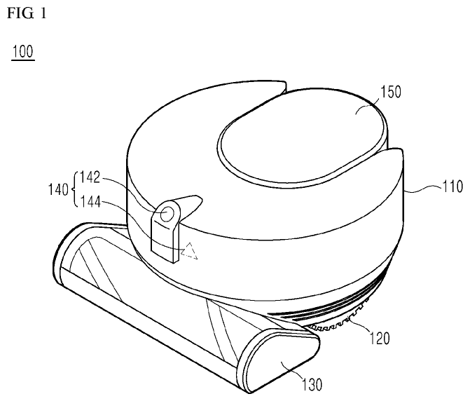

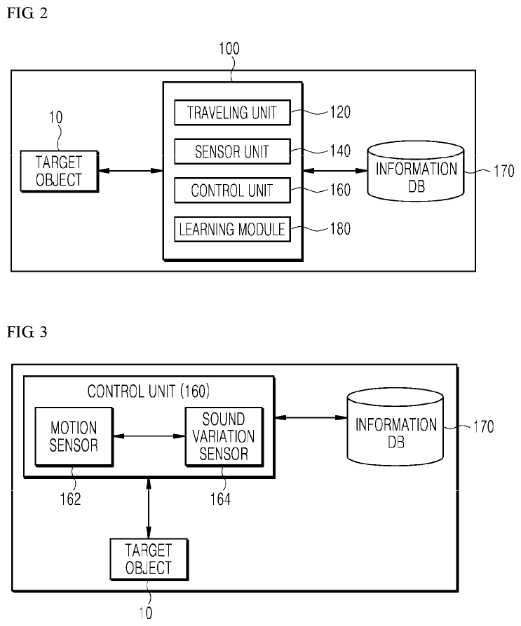

FIG. 1 is a perspective view illustrating a mobile robot capable of interacting with at least one target object to be sensed according to an embodiment of the present disclosure. FIG. 2 is a block diagram illustrating the mobile robot and the at least one target object according to an embodiment of the present disclosure.

Although, by way of example, the mobile robot to be described in the following embodiments is an autonomous vehicle, it is to be noted that the mobile robot may operate in any one of an autonomous mode, a semi-autonomous mode, or a manual mode, without departing from the scope or spirit of the present disclosure. In addition, although the mobile robot according to the embodiment of the present disclosure may be a cleaning robot, the present disclosure is not limited thereto, and it is to be noted that the mobile robot may be any robot capable of operating in an autonomous mode, a semi-autonomous mode, or the like.

Although, by way of example, the mobile robot according to the embodiment of the present disclosure is a cleaning robot that performs cleaning while traveling inside a home, the present disclosure is not limited thereto.

The mobile robot 100 according to this embodiment of the present disclosure may be adapted to sense an object that may collide with the mobile robot 100, and to avoid collision with the object through machine learning. Specifically, the mobile robot 100 according to this embodiment of the present disclosure may interact with at least one moving object capable of experiencing emotions.

The object with which the mobile robot 100 interacts will hereinafter be referred to as a target object 10 to be sensed. For example, the target object 10 to be sensed may denote an entity such as person or pet, which freely moves in indoor spaces such as a home or an office and is capable of expressing emotions such as surprise and fear. For exemplary purposes, the target object 10 in this embodiment of the present disclosure may be a young child.

Driving of the mobile robot 100 may be controlled according to external reactions (for example, a rejection reaction or a favorable reaction toward the mobile robot 100) of the target object 10 encountering the mobile robot 100.

Since the driving of the mobile robot 100 may be controlled according to external reactions of the target object 10, the mobile robot 100 may interact with the target object 10 while being driven. As a result, when a target object 10 which has a negative disposition toward the mobile robot 100 is in close proximity to the mobile robot 100, discomfort or inconvenience of the target object 10, caused by the mobile robot 100, may be reduced.

In order to enable the mobile robot 100 to interact with the target object 10, there is a need for the mobile robot 100 to learn external reactions of the target object 10 toward the mobile robot 100. To this end, the mobile robot 100 may include a main body 100 which forms an exterior of the mobile robot 100, a traveling unit 120 configured to move or rotate the main body 110, a sensor unit 140 configured to sense movement or sound of the target object 10 located within a predetermined distance from the main body 110, and a control unit 160 configured to control movement of the main body 110.

In more detail, the main body 110 may be formed in any one of various shapes, such as a circular shape, a polygonal shape, and the like. The shape of the main body 10 may be changed according to the conditions.

In addition, the main body 110 may include a suction unit 130 configured to suction air, dust, and the like. The main body 110 may include a suction device (not shown) configured to provide a suction force that allows the suction unit 130 to suction air, dust, and the like, and a dust collector 150 configured to filter out dust from the air suctioned through the suction unit 130.

The main body 110 of the mobile robot 100 may include a battery (not shown). The battery may supply power needed for all operations of the mobile robot 100, including the traveling unit 120 (to be described below). When the battery is discharged, the mobile robot 100 may return to a charging stand (not shown) to re-charge the battery, and while returning the mobile robot 100 may autonomously detect the position of the charging stand.

The traveling unit 120 may include at least one drive wheel capable of rotating or moving the main body 110. Although the drive wheel may be installed in any one surface of the main body 110, it is to be noted that the installation structure of the drive wheel may also be changed according to the installation conditions. In addition, the traveling unit 120 may further include a drive motor to rotate the drive wheel.

The sensor unit 140 may sense movement and sound of the at least one target object 10 when the mobile robot 100 moves into close proximity to the target object 10, located within a predetermined distance from the main body 110 and capable of expressing emotions toward the mobile robot 100.

To this end, the sensor unit 140 may include a camera 142 configured to acquire image data showing movement of the target object 10. The camera 142 may be a digital camera configured to generate images, still images, and moving images composed of still image frames, so that movement of the target object 10 moving toward the mobile robot 100 may be easily acquired.

In addition, the camera 142 may capture forward-view images of the main body 110. That is, the main body 110 may acquire forward-view images of the entire traveling region of the mobile robot 100, thereby preventing collision between the mobile robot 100 and nearby objects, including the at least one target object 10, and enabling the mobile robot 100 to avoid nearby obstacles.

Further, the camera 142 may also be used determine whether the mobile robot 100 is to perform cleaning, a start time for cleaning, or the like, by recognizing dust or foreign materials in a forward region with respect to the traveling direction of the main body 110 during traveling of the mobile robot 100.

In addition, the images captured by the camera 142 may be used as a reference to allow the control unit 160 (to be described below) to ascertain whether an object in the captured images is a target object 10 to be sensed.

In addition, the images captured by the camera 142 may be used to identify traveling-permitted spaces and traveling-restricted spaces of the main body 110.

The sensor unit 140 may also include a sound recognition unit 144 configured to acquire sound from the at least one target object 10. When the target object 10 and the mobile robot 100 move into close proximity to each other, the sound recognition unit 144 may acquire sound generated by the target object 10.

At this time, for convenience of description and better understanding of the present disclosure, it is assumed that the sound acquired from the target object 10 is a negative sound, expressing a desire of the target object 10 to avoid the mobile robot 100. That is, for the purpose of controlling movement of the main body 110 in this embodiment of the present disclosure, an amount of change in movement or sound of the target object 10 indicates a negative reaction toward the mobile robot 100. Therefore, it may be determined that a sound of the target object 10 acquired by the sound recognition unit 144 is a negative sound, expressing a desire of the target object 10 to avoid the mobile robot 100.

When the sensor unit 140 acquires information about the movement or sound of the at least one target object 10, the control unit 160 may control movement of the main body 110, based on the acquired information.

Specifically, the control unit 160 may determine whether the distance between the main body 110 and the target object 10 is shorter than a predetermined distance. Here, the predetermined distance may refer to a distance in which the camera 142 can sufficiently recognize the presence of the target object 10, and may be set differently according to various conditions, such as performance of the camera 142, a preset distance between the target object 10 and the mobile robot 100, and the like.

The control unit 160 may determine whether the distance between the main body 110 and the target object 10 is shorter than the predetermined distance, and may ascertain an identity of the target object 10. Here, an identity may refer to unique identification (ID) information (or a unique ID code) allocated to each target object that moves around a home and is capable of expressing emotions. As such, by allocating a unique identity indicating unique ID information to each target object that moves around a home, the unique identity may be used as a reference for easily determining whether any one target object 10 is in close proximity to the main body 110.

Here, it is assumed that the target object 10 that interacts with the mobile robot 100, referred to in the above description, is the same entity as the target object 10 of which the identity has been ascertained.

When the identity of the at least one target object 10 is ascertained as described above, the control unit 160 may determine whether a change in movement or sound of the target object 10 of which the identity has been ascertained occurs in response to a decrease in distance between the target object 10 and the main body 110.

In other words, when the distance between the main body 110 and the target object 10 to be sensed is shorter than a predetermined distance, the control unit 160 may record an execution operation executed by the mobile robot 100. In this case, the control unit 160 may recognize whether a change in movement or sound of the target object 10 of which the identity has been ascertained has occurred in response to the execution operation executed by the mobile robot 100. For example, when the distance between the main body 110 and the target object 10 of which the identity has been ascertained is shorter than the predetermined distance, when the target object 10 rejects or dislikes approach of the mobile robot 100, the target object 10 may move from one place to another place so as to avoid the mobile robot 100, or may express a rejection reaction such as shouting at the mobile robot 100.

When the target object 10 of which the identity has been ascertained has expressed a rejection reaction toward the mobile robot 100, and a change in movement or sound of the target object 10 is confirmed, the control unit 160 may adjust the operation of the mobile robot 100 such that the change in the movement or sound of the target object 10 that has expressed the rejection reaction may decrease.

In other words, when the traveling mobile robot 100 is in close proximity to the target object 10 of which the identity has been ascertained, if the target object 10 attempts to avoid the mobile robot 100 (for example, by running away from the mobile robot 100) or expresses a rejection reaction (for example, crying, shouting, screaming) toward the mobile robot 100, the operation of the mobile robot 100 may be adjusted to be driven at a reduced level, so as to reduce the rejection reaction of the target object 10.

Here, adjusting the operation of the mobile robot 100 may refer to reducing a traveling speed of the mobile robot 100 or reducing noise generated in the process of suctioning dust or foreign materials, but the scope or spirit of the present disclosure is not limited thereto. Specifically, when the degree of movement of the main body 110 is reduced, several behaviors of the mobile robot 100 may be simultaneously reduced in level, or only a specified behavior of the mobile robot 100 may be reduced in level.

When the control unit 160 has sensed whether a change in movement or sound of the target object 10 of which the identity has been ascertained has occurred in response to a decrease in distance between the target object 10 and the main body 110, the control unit 160 may learn, in association with the identity of the target object 10, the execution operation executed by the mobile robot 100 and the change in movement or sound of the target object 10. Thereafter, based on the learning result, the control unit 160 may analyze a correlation between the execution operation of the mobile robot 100 and the change in movement or sound of the target object 10, for each target object 10 identity.

In more detail, a plurality of target objects 10 to be sensed, such as a child, an adult, or a pet, may be present in an indoor space such as a home. Each target object 10 may have a different reaction to the movement of the main body 110. Accordingly, the control unit 160 may store information for each identity (for example, reaction information about movement of the mobile robot 100 according to the type of target object) of the target objects 10 which have expressed a reaction toward the execution operation of the mobile robot 100, and may perform learning so as to identify the target object 10 according to the reaction of the target object 10 to the movement of the main body 110, based on the stored information. Based on the learning information, the operation to be executed by the mobile robot 100 may be adjusted in a different manner for each target object 10 identity.

Thereafter, the adjusting operation of the mobile robot 100 may be determined based on reaction information of the target object 10 for each of the analyzed identities. That is, when the main body 110 moves to within a predetermined distance or less from the target object 10 of which an identity has been ascertained, and the change in movement or sound of the target object 10 of increases, the control unit 160 may control the mobile robot 100 such that the mobile robot 100 operates at a reduced level.

Specifically, the adjusting operation of the mobile robot 100 may be automatically performed, based on a pre-learned learning result, and thereby cause the amount of change in movement or sound of the target object 10 of which an identity has been ascertained to decrease. As a result, adverse effects on the psychological stability of the at least one target object 10 which expresses a rejection reaction toward the mobile robot 100, and inconvenience of a user who uses the mobile robot 100, may be reduced.

Furthermore, identity information for each of the at least one target object 10 in a home, and information about the change in movement or sound of each target object 10 of which an identity has been ascertained in response to the execution operations of the mobile robot 100, may be stored in an information database (DB) 170.

In addition, learning the execution operation of the mobile robot 100 and the change in movement or sound of each target object 10 in association with the identity of the target object 10 may be performed by a learning module 180.

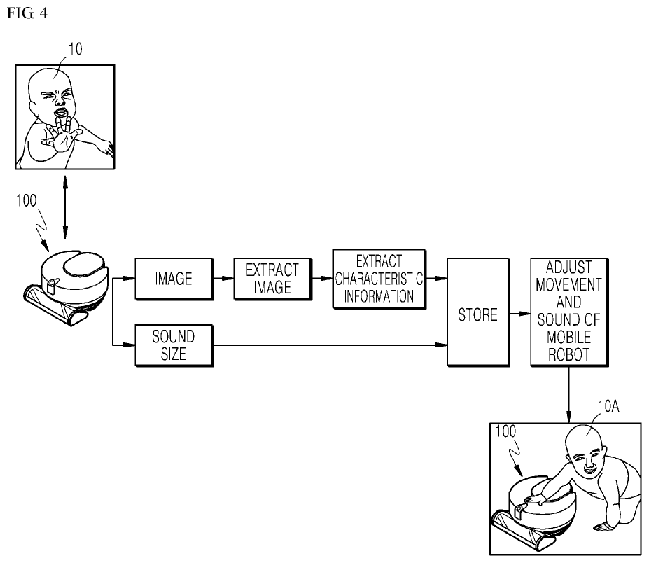

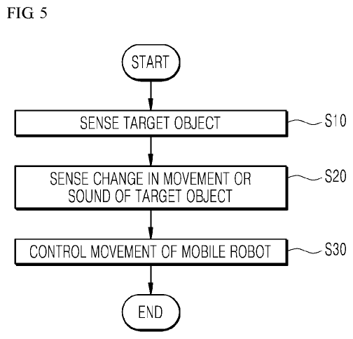

A method for controlling driving of the mobile robot 100 with respect to at least one target object 10, and a method for enabling interaction between the mobile robot and the at least one target object 10, will hereinafter be described with reference to FIGS. 3 and 4.

FIG. 3 is a schematic diagram illustrating the mobile robot 100 and the at least one target object 10 to be sensed according to an embodiment of the present disclosure. FIG. 4 is a conceptual diagram illustrating a method for enabling interaction between the mobile robot 100 and the at least one target object 10 according to an embodiment of the present disclosure.

Referring to FIGS. 3 and 4, when the distance between the mobile robot 100 and the at least one target object 10 of which the identity has been ascertained is shorter than a predetermined distance, the control unit 160 of the mobile robot 100 may identify the amount of change in movement or sound of the target object 10 of which an identity has been ascertained using a motion sensor 162 or a sound variation sensor 164.

Information about the identified amount of change in movement or sound of the object 10 of which the identity has been ascertained may be stored in the information DB 170. Here, the amount of change in movement of the target object 10 may be extracted as an image, and characteristics may be extracted from the extracted image and stored in the information DB 170. The stored image may be used as a reference for adjusting the execution operation of the mobile robot 100. That is, the control unit 160 may extract, through the images extracted from the camera 142, the target object 10 of which the identity has been ascertained, and may thereby be able to reduce the change in movement or sound of the target object 10 in response to the execution operation of the mobile robot 100.

Thereafter, when the main body 110 of the mobile robot 110 moves into close proximity to the target object 10 of which the identity has been ascertained, and when it is determined that the change in movement or sound of the target object 10 increases, the control unit 160 may adjust the execution operation of the mobile robot 100. Particularly, the control unit 160 may reduce movement of the main body 110 such that the change in movement or sound of the target object 10 of which the identity has been ascertained decreases.

According to the above-described embodiment of the present disclosure, under the condition that the mobile robot 100 is in contact with the moving target object 10 during traveling, or is located within a predetermined distance from the target object 10 during traveling, when the target object 10 expresses a negative reaction (for example, crying, screaming, retreating backward) toward the mobile robot 100, the mobile robot 100 may learn and store information regarding the negative reaction of the target object 10. At this time, when the distance between the target object 10 and the mobile robot 100 is shorter than the predetermined distance, the main body 110 of the mobile robot 100 may be designed to interact with the target object 10, by autonomously reducing the amount of noise generated during cleaning or being driven at a lower level, based on the learned and stored information. As a result, a negative reaction of a user of the mobile robot 100 may be reduced. Specifically, even when the target object 10 which expresses a negative reaction toward the mobile robot 100 resides in a home in which the mobile robot 100 travels, the mobile robot 100 may autonomously control the driving of the mobile robot 100 according to the reactions of the target object 10, resulting in inconvenience, caused by the mobile robot, being reduced.

The amount of change in movement or sound of the target object 10 of which the identity has been ascertained in response to the movement of the main body 110 of the mobile robot 100 may change over time. For example, whereas a child in a home may at first react negatively toward the mobile robot 100, his or her negative reaction toward the mobile robot 100 may gradually decrease over time.

In such a case, control of the movement of the main body 110 of the mobile robot 100 may also need to be changed. To this end, as the distance between the main body 110 of the mobile robot 100 and the target object 10 of which the identity has been ascertained decreases, the amount of change in movement or sound of the target object 10 may be checked at intervals of a predetermined time within a predetermined time range.

In other words, when movement of the main body 110 of the mobile robot 100 is adjusted such that the amount of change in movement or sound of the target object 10 of which the identity has been ascertained decreases, the amount of change in movement or sound of the target object 10 may decrease. Thereafter, once a predetermined time has elapsed, during which the object 10 of which the identity has been ascertained becomes familiar with the moving mobile robot 100, the amount of change in movement of the main body 110 of the mobile robot 100 may also be changed in response thereto, as shown in 10A of FIG. 4. Therefore, when the mobile robot 100 of which the movement has been adjusted is traveling within a predetermined distance from the target object 10 of which an identity has been ascertained, once a predetermined time has elapsed, the control unit 160 of the mobile robot 100 may determine that the target object 10 has become familiar with the movement of the mobile robot 100, and the control unit 160 may reduce the distance between the main body 110 and the target object 10 and determine whether the amount of change in movement or sound of the target object 10 changes.

In this case, if the amount of change in movement or sound of the target object 10 of which the identity has been ascertained remains with a predetermined range, the control unit 160 may adjust the operation of the mobile robot 100 such that the mobile robot 100 continues to perform the operations that the mobile robot 100 was previously performing.

For example, when the change in movement or sound of the target object 10 of which the identity has been ascertained is considered to be small, the movement of the main body 110 may not be adjusted, such that the mobile robot 100 may continue traveling (cleaning). In contrast, if a change in movement or sound of the object 10 of which the identity has been ascertained occurs, the control unit 160 may adjust the movement of the main body 110 of the mobile robot 100, such that inconvenience or discomfort of the target object 10, caused by the mobile robot 100, may be reduced.

A method for enabling interaction between a mobile robot and at least one target object to be sensed according to the present disclosure will hereinafter be described with reference to the attached drawings.

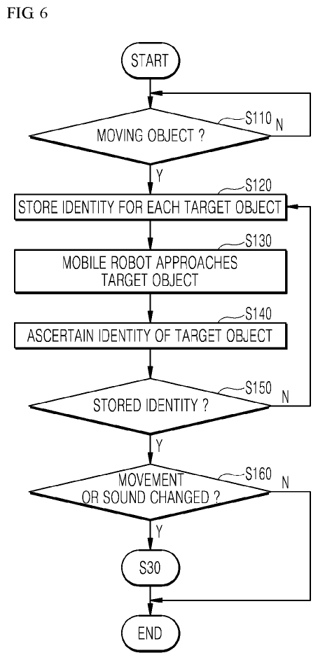

FIG. 5 is a flowchart illustrating a method for enabling interaction between a mobile robot and at least one target object to be sensed according to an embodiment of the present disclosure. FIG. 6 is a flowchart illustrating a method for enabling interaction between a mobile robot and at least one target object having a unique identity according to an embodiment of the present disclosure.

In the description of the drawings to follow, where the reference numbers are the same as those of the apparatus and constituent elements described in FIGS. 1 to 4, it will be assumed that the reference numbers refer to the same apparatus and constituent elements as those described in FIGS. 1 to 4, and a detailed description thereof will thus be omitted.

Although, by way of example, the mobile robot in the method for enabling interaction between the mobile robot and the at least one target object to be sensed according to this embodiment of the present disclosure is an autonomous vehicle in the description of the drawings to follow, it is to be noted that the mobile robot may operate in an any one of an autonomous mode, a semi-autonomous mode, or a manual mode, without departing from the scope or spirit of the present disclosure.

In addition, although, by way of example, the mobile robot according to the embodiment of the present disclosure is a cleaning robot that performs cleaning while traveling inside a home, the present disclosure is not limited thereto.

The mobile robot 100 according to this embodiment of the present disclosure may be adapted to sense an object that may collide with the mobile robot 100, and to avoid collision with the object through machine learning. Specifically, the mobile robot 100 according to this embodiment of the present disclosure may be adapted to interact with at least one moving object (hereinafter referred to as a target object 10) capable of experiencing emotions, and driving of the mobile robot 100 may be controlled according to external reactions of the at least one target object 10. In this case, the external reactions of the at least one target object 10 may include a rejection reaction or a favorable reaction, or the like, toward the mobile robot 100.

Since the driving of the mobile robot 100 according to this embodiment of the present disclosure may interact with the at least one target object 10 and may be controlled according to the external reactions of the at least one target object 10, when a target object 10 which expresses a rejection reaction toward the mobile robot 100 is in close proximity to the mobile robot 100, discomfort or inconvenience of the target object 10, caused by the mobile robot 100, may be reduced.

The method for enabling interaction between the mobile robot 100 and the at least one target object 10 may include a process of sensing the at least one target object 10 while the main body 110 of the mobile robot 100 is moving, rotating, and traveling (S10), sensing an amount of change in movement or sound of the target object 10 located within a predetermined distance from the main body 110 (S20), and controlling an execution operation of the mobile robot 100 while communicating with the main body 110, based on the amount of change in movement or sound of the target object 10 (S30).

A method for controlling the execution operation of the mobile robot 100 will hereinafter be described in detail. When the main body 110 of the mobile robot 10 is located within a predetermined distance from the target object 10 to be sensed, it may be determined whether the target object 10 is moving (S110). When the distance between the main body 110 of the mobile robot 100 and the target object 10 is shorter than the predetermined distance, an identity of the target object 10 may be stored (S120).

Here, the identity of the target object 10 may refer to unique identification (ID) information (or a unique ID code) allocated to each target object that moves around a home and is capable of expressing emotions toward the mobile robot 100. As described above, the identity indicating unique ID information allocated to each target object that moves around a home may be used as a reference for easily determining whether the main body 110 is in close proximity to any one of the target objects 10.

Here, it is assumed that the above-mentioned target object 10 that interacts with the mobile robot has the same configuration as the target object 10 of which the identity has been ascertained.

It may then be determined whether the amount of change in movement or sound of the target object 10 has changed in response to the shorter distance between the main body 110 of the mobile robot 110 and the object 10 (S130). When it is determined in the step S130 that the amount of change in movement or sound of the target object 10 has changed, an identity of the target object 10 may be ascertained (S140).

When the identity of the target object 10 has been ascertained and the mobile robot 100 is located within the predetermined distance from the target object 10, an execution operation of the mobile robot 100 may be recorded, and the amount of change in movement or sound of the target object 10 of which the identity has been ascertained may be sensed (S150).

Thereafter, when it is determined that the identity of the target object 10 in which the amount of change in movement or sound has occurred is the target object 10 of which the identity has been ascertained, a correlation between movement of the main body 110 and the amount of change in movement or sound of the target object 10 of which the identity has been ascertained may be analyzed (S160).

For example, when the amount of change in movement or sound of the target object 10 of which the identity has been ascertained is considered to be high, the main body 110 may be controlled such that the movement thereof is reduced, so as to decrease the amount of change in movement or sound of the mobile robot 100 (S30).

In more detail, for example, when a child in a home reacts to the movement of the main body 110 of the mobile robot 100 by crying (sound), or steps backward to move away from the mobile robot 100 (movement), the movement of the main body 110 may be controlled in response to the change in movement or sound of the child, such that the amount of change in movement or sound of the child, may be reduced.

More specifically, controlling the movement of the main body 110 may refer to reducing a driving or traveling speed of the mobile robot 100 or reducing noise generated in the process of suctioning dust or foreign materials, or the like. In particular, when the degree of movement of the main body 110 is reduced, several behaviors of the mobile robot 100 may be simultaneously reduced in level, or only a specified behavior of the mobile robot 100 may be reduced in level.

When the identity of the at least one target object 10 is ascertained, the execution operation of the mobile robot 100 and the change in movement or sound of the target object 10 may be learned in association with the identity of the target object 10, so that only information of the target object 10 of which the identity has been ascertained in which a change in movement or sound has occurred in response to movement of the main body 110 of the mobile robot 100 is stored.

In other words, while objects capable of interfering with the movement of the mobile robot 100 (for example, collision or contact with the mobile robot 100) in indoor spaces such as a home or an office may include not only the target object 10 that is capable of moving and expressing emotions toward the mobile robot 100, but also various electronic appliances designed to be automatically driven, and other devices (for example, a chair provided with wheels, and the like) capable of traveling. In this case, the mobile robot 100 may be configured to ascertain an identity only of target objects that are capable both of moving and of expressing emotions toward the mobile robot 100, and not to sense the above-mentioned traveling devices which are capable only of moving.

In addition, a plurality of target objects 10 to be sensed, such as a child, an adult, or a pet, may be present in an indoor space such as a home. Each target object 10 may have a different reaction to movement of the main body 110. Accordingly, information may be stored for each identity (for example, reaction information about movement of the mobile robot 100 according to the type of target object) of the at least one target object 10 that has expressed a reaction to the execution operation of the mobile robot 100, and may perform learning so as to identify the target object 10 according to the reaction of the target object 10 toward the movement of the main body 110, based on the stored information.

Thereafter, the control unit 160 may analyze a correlation between the movement of the mobile robot 100 and the amount of change in movement or sound of the at least one target object 10 of which the identity has been ascertained, in response to the movement of the main body (110). As described above, a variety of target objects to be sensed by the mobile robot 100, such as an adult, a child, a pet, moving electronic appliances, devices capable of mechanical traveling, and the like, may be present in indoor spaces at a home or an office. Each object may express different reactions to movement of the main body 110. Accordingly, identity information (for example, type information of the target object, information about reactions of the target object toward the movement of the main body, and the like) may be stored for each target object that reacts to the movement of the mobile robot 100, and based on the stored information, the corresponding target object may be identified by referring to the information about reactions toward movement of the main body 110. Based on the information about reactions of the target object toward movement of the main body 110, the execution operation of the mobile robot 100 (for example, controlling the driving of the main body 110) may be adjusted.

Thereafter, the amount of change in movement or sound of the target object 10 of which the identity has been ascertained in response to the movement of the main body 110 may be analyzed. That is, when the main body 110 moves to within a predetermined distance or less from the target object 10 of which the identity has been ascertained, whether the amount of change in sound of the target object 10 increases or decreases, and whether the amount of change in movement of the target object 10 increases or decreases, may be analyzed.

Through the analysis, when the main body 110 approaches the target object 10 of which the identity has been ascertained and the amount of change in movement or sound of the target object 10 increases, the degree of movement of the main body 110 may be reduced, such that the amount of change in movement or sound of the target object 10 decreases.

Accordingly, when external reactions of the target object 10 toward the mobile robot 100 have been learned, and the distance between the target object 10 and the mobile robot 100 is shorter than a predetermined distance, the movement of the main body 110 of the mobile robot 100 may be controlled based on the result of the learning, such that negative reactions of the target object 10 toward the mobile robot 100 may be reduced, and inconvenience or discomfort of the target object 10, caused by the mobile robot 100, may be reduced.

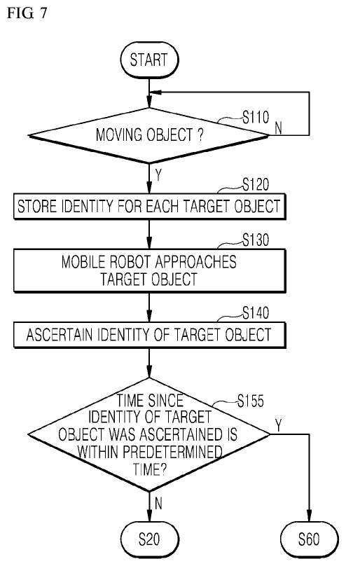

FIG. 7 is a flowchart illustrating a method for enabling interaction between at least one target object to be sensed and a mobile robot within a predetermined time range according to an embodiment of the present disclosure.

Referring to FIG. 7, a method for enabling interaction between the mobile robot 100 and the at least one target object 10 to be sensed according to this embodiment of the present disclosure may include determining, when the distance between the main body 110 and the target object 10 is shorter than a predetermined distance, whether the target object 10 is a moving object (S110), and storing the identity of the target object 10 (S120).

Thereafter, it may be determined whether the amount of change in movement or sound of the target object 10 has changed in response to the shorter distance between the main body 110 and the target object 10 (S130). When it is determined in the step S130 that the amount of change in movement or sound of the target object 10 has changed, an identity of the target object 10 may be ascertained (S140).

Here, when the main body 110 is located within the predetermined distance from the target object 10 of which the identity has been ascertained, the mobile robot 100 may learn and store information about the change in movement or sound of the target object 10 of which the identity has been ascertained.

In more detail, when the distance between the target object 10 and the mobile robot 100 is shorter than the predetermined distance, the main body 110 of the mobile robot 100 may be designed to interact with the target object 10, by autonomously reducing the amount of noise generated during cleaning or being driven at a lower level, based on the learned and stored information. As a result, a negative reaction of a user of the mobile robot 100 may be reduced. Specifically, even when the target object 10 which expresses a negative reaction toward the mobile robot 100 resides in a home in which the mobile robot 100 travels, the mobile robot 100 may autonomously control the driving thereof according to the reactions of the target object 10, resulting in inconvenience, caused by the mobile robot, being reduced.

The amount of change in movement or sound of the target object 10 of which the identity has been ascertained in response to the movement of the main body 110 of the mobile robot 100 may change over time. For example, whereas a child in a home may at first react negatively toward the mobile robot 100, his or her negative reaction toward the mobile robot 100 may gradually decrease over time.

In such a case, control of the movement of the main body 110 of the mobile robot 100 may also need to be changed. To this end, as the distance between the main body 110 of the mobile robot 100 and the target object 10 of which the identity has been ascertained decreases, the amount of change in movement or sound of the target object 10 may be determined at intervals of a predetermined time within a predetermined time range (S155).

In other words, when movement of the main body 110 of the mobile robot 100 is adjusted such that the amount of change in movement or sound of the target object 10 of which the identity has been ascertained decreases, the amount of change in movement or sound of the target object 10 may decrease. Thereafter, once a predetermined time has elapsed, during which the target object 10 of which the identity has been ascertained becomes familiar with the moving mobile robot 100, the amount of change in movement of the main body 110 of the mobile robot 100 may also be changed in response thereto.

That is, when the mobile robot 100 of which the movement has been adjusted is traveling within a predetermined distance from the target object 10 of which the identity has been ascertained, once a predetermined time has elapsed it may be determined that the target object 10 has become familiar with the movement of the mobile robot 100. Then. the distance between the main body 110 and the target object 10 may be reduced, and it may again be determined whether the amount of change in movement or sound of the target object 10 changes.

In this case, when the amount of change in movement or sound of the at least one target object 10 of which the identity has been ascertained remains with a predetermined range, the operation of the mobile robot 100 may be adjusted such that the mobile robot 100 continues to perform the operation that the mobile robot 100 was previously performing (S20).

For example, when the change in movement or sound of the target object 10 of which the identity has been ascertained is considered to be small, the movement of the main body 110 may not be adjusted, such that the mobile robot 100 may continue traveling (cleaning).

As described above, the embodiments of the present disclosure may provide a mobile robot which, during traveling, may collect information about a change in movement or sound of at least one target object capable of reacting externally (expressing emotions) toward the mobile robot, learn the collected information, and control driving of the mobile robot when the target object to be sensed and a main body of the mobile robot move to within close proximity of each other, such that inconvenience or discomfort of the target object, caused by the mobile robot, may be reduced.

In addition, when the main body of the mobile robot is located within a predetermined distance from the at least one target object to be sensed, and a change in movement or sound of the target object occurs, movement of the main body may be controlled such that the amount of change in movement or sound of the target object in response to the mobile robot may be reduced, thereby resulting in inconvenience or discomfort of the target object, caused by the mobile robot, being reduced.

In addition, after a predetermined time has passed since driving of the main body of the mobile robot was controlled, when the main body of the mobile robot and the target object again move into close proximity to each other, whether or not to control the driving of the main body may be determined based on whether or not there is a change in movement or sound of the target object. In other words, if there is no change in the movement or sound of the target object even though the main body of the mobile robot and the target object have moved into close proximity to each other, the mobile robot may be continuously driven, without any additional movements of the main body being controlled, so that the mobile robot may continue to perform cleaning.

In the foregoing, while specific embodiments of the present disclosure have been described and illustrated, the scope or spirit of the present disclosure is not limited thereto, it will be understood by those skilled in the art that various changes and modifications can be made to other specific embodiments without departing from the spirit and scope of the present disclosure. Therefore, the scope of the present disclosure is defined not by the detailed description, but by the claims and their equivalents, and all variations within the scope of the claims and their equivalents are to be construed as being included in the present disclosure

Although the present disclosure has been described with reference to the embodiments, various changes or modifications can be made by those skilled in the art. Accordingly, it is to be understood that such changes and modifications are within the scope of the invention.

1. A mobile robot capable of interacting with at least one target object to be sensed, comprising:
a main body forming an exterior of the mobile robot;
a traveling unit configured to move and rotate the main body;
a sensor unit including at least one sensor, configured to sense movement or sound of the at least one target object located within a predetermined distance from the main body; and
a control unit configured to control movement of the main body while communicating with the traveling unit and the sensor unit, wherein the control unit is configured to perform operations comprising:
(A) determining whether a distance between the main body and the at least one target object is shorter than the predetermined distance;
(B) ascertaining an identity of the at least one target object when the distance between the main body and the at least one target object is shorter than the predetermined distance;
(C) recording an execution operation executed by the mobile robot in an area in which the main body is located within the predetermined distance from the at least one target object, and sensing a change in movement or sound of the at least one target object of which the identity has been ascertained; and
(D) adjusting the operation of the mobile robot such that the amount of change in movement or sound of the at least one target object of which the identity has been ascertained decreases.

2. The mobile robot according to claim 1, wherein the control unit is configured to perform an operation of:
(C-1) learning, in association with the identity of the at least one target object, the execution operation of the mobile robot and the change in movement or sound of the at least one target object, upon completion of the operation (A), the operation (B), and the operation (C).

3. The mobile robot according to claim 2, wherein the control unit is configured to perform an operation of:
(C-2) analyzing, through the result of the learning in the operation (C-1), a correlation between the execution operation of the mobile robot and the change in movement or sound of the at least one target object, for each target object identity.

4. The mobile robot according to claim 3, wherein the control unit is configured to determine an operation of the mobile robot to be adjusted in the operation (D), based on the correlation between the execution operation of the mobile robot and the change in movement or sound of the at least one target object analyzed in the operation (C-2).

5. The mobile robot according to claim 1, wherein the control unit is configured to repeatedly perform the operation (C) at intervals of a predetermined time within a predetermined time range after completion of the operation (D).

6. The mobile robot according to claim 1, wherein when the amount of change in movement or sound of the at least one target object of which the identity has been ascertained is within a predetermined range, even if the distance between the main body and the at least one target object of which the identity has been ascertained decreases in the operation (C), the control unit is configured to adjust, in the operation (D), the operation of the mobile robot such that the mobile robot continues to perform an operation that the mobile robot was previously performing.

7. The mobile robot according to claim 1, wherein the control unit is configured to include a camera for capturing an image of the at least one target object to be sensed.

8. The mobile robot according to claim 7, wherein the control unit is configured to ascertain an identity of the at least one target object based on the image of the at least one target object captured by the camera.

9. A method for enabling interaction between a mobile robot and at least one target object to be sensed, the method comprising performing steps comprising:
(A) moving a main body of the mobile robot, and determining whether a distance between the main body and the at least one target object is shorter than a predetermined distance;
(B) ascertaining an identity of the at least one target object when the distance between the main body and the at least one target object is shorter than the predetermined distance;
(C) recording an execution operation executed by the mobile robot in an area in which the main body is located within the predetermined distance from the at least one target object, and sensing a change in movement or sound of the at least one target object of which the identity has been ascertained; and
(D) adjusting operation of the mobile robot such that the amount of change in movement or sound of the at least one target object of which the identity has been ascertained decreases.

10. The method according to claim 9, further comprising performing a step of:
(C-1) learning, in association with the identity of the at least one target object, the execution operation of the mobile robot and the change in movement or sound of the at least one target object, upon completion of the step (A), the step (B), and the step (C).

11. The method according to claim 10, wherein after the step (C-1) is performed, the method further comprises performing a step of:
(C-2) analyzing, through the result of the learning in the step (C-1), the correlation between the execution operation of the mobile robot and the change in movement or sound of the at least one target object, for each target object identity.

12. The method according to claim 9, further comprising repeatedly performing the step (C) at intervals of a predetermined time within a predetermined time range after completion of the step (D).

13. The method according to claim 9, wherein when the amount of change in movement or sound of the at least one target object of which the identity has been ascertained is within a predetermined range, even if the distance between the main body and the at least one target object of which the identity has been ascertained decreases in the step (C), the method further comprises adjusting, in the step (D), the operation of the mobile robot such that the mobile robot continues to perform an operation that mobile robot was previously performing.
